(19) United States
(12) Patent Application Publication
(10) Pub. No.: US 2011/0140555 A1
(43) Pub. Date: Jun. 16, 2011

(54) VARIABLE SPEED CONSTANT FREQUENCY MOTOR

(76) Inventors: LEO G. NICKOLADZE, Kailua, HI (US); Hildegard K. Marks, Kailua, HI (US)

(21) Appl. No.: 12/978,203

(22) Filed: Dec. 23, 2010

Related U.S. Application Data
(63) Continuation of application No. 12/578,392, filed on Oct. 13, 2009, now abandoned.
Application No. 12/578,392 is a continuation of application No. 11/965,556, filed on Dec. 27, 2007, now abandoned.
Application No. 11/965,556 is a continuation of application No. 11/746,468, filed on May 9, 2007, now abandoned.
Application No. 11/746,468 is a continuation of application No. 11/325,859, filed on Jan. 5, 2006, now abandoned.
Application No. 11/325,859 is a continuation of application No. 11/022,134, filed on Dec. 23, 2004, now abandoned.
Application No. 11/022,134 is a continuation of application No. 10/786,273, filed on Feb. 25, 2004, now abandoned.
Application No. 10/786,273 is a continuation of application No. 10/052,287, filed on Jan. 18, 2002, now abandoned.
Application No. 10/052,287 is a continuation of application No. 09/676,182, filed on Sep. 29, 2000, now abandoned.
Application No. 09/676,182 is a continuation of application No. 09/258,376, filed on Feb. 26, 1999, now abandoned.
(60) Provisional application No. 60/076,309, filed on Feb. 27, 1998.

(51) Int. Cl. H02K 17/16; H02K 11/00

(52) U.S. Cl. 310/72; 310/124

(57) ABSTRACT

A variable speed isosychronized motor includes two annular stators conformed for variable angular alignment relative to each other and a common rotor extending a plurality of isolated loops to cross-induce power between stators once such are angularly displaced. In this form of losses, attendant to speed variation through stator phasing are reduced. Electrical compensation may be inserted between each terminal pair. Potentiometers in parallel with capacitors and may be inserted between the respective terminals to expand the operating range of the device.

### CROSS-REFERENCE TO RELATED APPLICATIONS

The present application is a continuation of application Ser. No. 12/578,392, filed Oct. 13, 2009, which is a continuation of co-pending application Ser. No. 11/965,556, filed Dec. 27, 2007, which is a continuation of Ser. No. 11/746,468, filed May 9, 2007, now abandoned, which is a continuation of Ser. No. 11/325,859, filed Jan. 5, 2006, now abandoned, which is a continuation of application Ser. No. 11/022,134, filed Dec. 23, 2004, now abandoned, which is a continuation of patent application Ser. No. 10/786,273, filed Feb. 25, 2004, now abandoned, which is a continuation of patent application Ser. No. 10/052,287, filed Jan. 18, 2002, now abandoned, which is a continuation of patent application Ser. No. 09/676,182, filed Sep. 29, 2000, now abandoned, which is a continuation of patent application Ser. No. 09/258,376, filed Feb. 26, 1999, now abandoned, which claims priority to provisional Application No. 60/076,309, filed Feb. 27, 1998. All of these applications are expressly incorporated by herein by reference as though fully set forth.

### BACKGROUND OF THE INVENTION

1. Field of Invention

The present invention relates to electrical motors referenced to an AC signal or utility grid, and More particularly to in electrical motors of the variable frequency type.

2. Description of Related Art

In my prior U.S. Pat. No. 4,229,689, issued on Oct. 25, 1980, and U.S. Pat. No. 4,701,691, issued on Oct. 20, 1987, the contents which are hereby incorporated by reference as if set forth in full herein, I have explained a synchronous generator for phase and frequency synchronized operation with the AC power grid or source. In a “motoring mode (below synchronous speed), the VSI Generator, acting as a wound rotor machine, delivers the highest torque per ampere of any available alternating current motor, and thus has much less effect on the power utility line (mains). The VSI Motor is singularly capable of decreasing this high “inrush” required by as much as 70%. At the same time, the torque can be increased by more than double the induction generator's capability, thus shortening the time that the starting load is on the utility line (mains). This phenomenon is caused by the two internal VSI sets of windings in parallel, acting as wound rotor motors. Wound rotor motors are known for their very low starting current and very high (if necessary) starting torque. Thus, the acceleration time for the turbine to reach its full speed can be made quite short. This will not cause too much, or too long, of a voltage dip, so common when other motors are used.

The conversion of energy in electromechanical devices involves exchanges between torque, speed and induced current. This conversion of energy is symmetrical, i.e., the exchange can occur from mechanical to electrical effects or visa versa. Devices that effect this exchange are well known, and frequently take the form of an Induction motor.

The characteristics of these motors include one or more stators excited by an alternating current to develop a magnetic field. In the simplest sense the effect of a motor results when an electrical system causes a current to flow through conductors exposed to a magnetic field. This magnetic field then induces current in the rotor, which may be wound or squirrel cage type in design. As a consequence of this induction attraction between the rotor and stator poles occurs, advancing the rotor in rotation which then causes further induced currents therein. In the art the most common form for electromechanical devices providing motor action is the form known as a singly fed, wound, induction device. This form refers to a stator and rotor assembly wherein the stator or field is the only assembly tied to external electrical circuit and the rotor is a magnetically coupled unconnected loop.

This type of device exchanges mechanical with electrical energy by magnetic coupling into rotor loops and thus a phase difference must exist between the magnetic vector of the field and the magnetic vector of the rotor. This difference is referred to in the art as the slip rate. Motors of this type of design have found wide acceptance in the Industry and public market place. While well suited for applications like fans or other devices where the motor rate is essentially unconstrained, little control is available or necessary for controlling speed. Simply, induction motors characteristically reach an optimum slip angle, a. slip angle or speed at which the torques balance out. Should other speeds be desired elaborate loading arrangements need be made which quickly become inefficient.

For these reasons various techniques were devised in the past which in one way or another allow for the adjustment of speed in an induction motor. These techniques, typically, entail control over the net flux field in the stators which in many instances oppose each other to affect a speed change. Thus, power loss is inherent in most prior art speed control arrangements, a power loss which is not always tolerable.

One common example of a starting arrangement for turbines is an arrangement known as the “3-step acceleration starter” in which loop resistance in the induction device is incrementally reduced as the shaft speed increases. Other similar devices have been developed which, again change the operating current of the rotor. Most induction machines usually require about six (6) times or more of the rated output amperes when used as motors for starting turbines. Unfortunately, a well designed, efficient, induction generator (not motor) may go to eight (8) times or more of the rated amperes for starting. On small (low capacity) systems this may increase starting time to an intolerable degree because of the large voltage drop.

In consequence, most singly fed induction devices are limited in operating range or suffer power loss in the form of the heat caused by the power drop across the winding resistance. Since heat is the primary concern in any electromechanical device an expanded operating range is thus achieved with substantial tradeoffs. Simply, the present state of the art trades off power range into heat in order to obtain a wider dynamic range.

For the foregoing reasons a technique for effecting speed control in an induction motor with minimal power loss has been sought and it is one such technique that is disclosed herein. We have discovered that improvements in operating range can be effected by R-L-C compensation between multiple stages both in 10 inverted and non-inverted connection. Accordingly, the discovered Resistance-Inductance-Capacitance R-L-C compensation obtains substantial operating range and efficiency benefit and it is this compensation that is set out herein.

### BRIEF SUMMARY OF INVENTION

In one aspect of the present invention, an induction motor structure in which two stators are coaxially arranged around a common rotor. Or two stators that are coaxially arranged around two rotors coaxially arranged on a shaft connected in parallel.

One of the stators is then mounted for rotation relative the other. The rotor or rotors extending through the common interior of these two stators then, in the course of rotation, develops induced current flows as result of passage across the displaced magnetic fields.

In practice each of the stators is arranged as a polyphase structure, excited by three-phase 60-cycle conventional supply. As result the magnetic vector in each stator progresses in rotation at 60 cycles per second one leading the other by angle (phase) of the angular adjustment. The resulting induced current in the rotor thus reflect the superposition of each stator crossing, of opposite polarity to the stator phase. As consequence a virtual slip angle is developed, a slip angle which modifies the torque and speed of the motor. Thus, by changing the relative phase angle between the two stators virtually any speed can be obtained. One should note that the foregoing is generally applicable to rotors both of the wound and squirrel cage type design.

In the past the windings, or the cage bars, have not been isolated from each other and, in fact, heavy conductor rings characterize the ends of a prior art squirrel cage rotor. As result a current flow distribution across the rotor is set up which reflects the inducing field. It has been found in the case of a dual field arrangement, displaced in phase, a complex pattern is established in the rotor which includes eddies across the adjacent windings or bars. This pattern results in power losses and response nonlinearities which are best avoided.

Accordingly, a dual stator configuration is disclosed herein with the stators arranged coaxially about a common rotor conformed as a set of isolated loops. By virtue of this isolation the induced current flows are limited within each loop which therefore avoids the complex cross flow patterns. Thus, adjustment of one stator relative the other resolves itself in a superposed current pattern in each loop which then sets the slip angle or rate of the rotor.

To provide a simple and convenient modification for the rotor loops for the singly fed induction assembly for improvements to an inductive device which expand the operating range thereof. These and other objects are accomplished within the present invention by inserting into the windings of a singly fed induction assembly resistive, inductive, and capacitive components for controlling the power factor therein. In one alternative, the inductive device thus modified is of a multi-phase configuration, e.g., a three phase motor, having a wound armature thus conformed then carries current waveforms across the loops at the slip frequency. This condition is fulfilled for all rates of slip and is a characteristic condition of singly fed induction devices.

A singly fed induction device, in accordance with the foregoing description, exhibits a linear increase in rotor 5 current with slip rate. This linear increase continues until the out-of-phase component of the rotor impedance becomes dominant. At this point the torque relationship with slip rate begins to fall off significantly, thus defining the operating peak of the device. Accordingly, as the out-of-phase components increase, the field pattern by which torque is produced becomes less favorable.

The above method is a dual stator configuration with the stators arranged coaxially about a common rotor and each of the two rotors coaxially arranged on a shaft and connected in parallel. The first of which is rendered as an exciter portion and the second as a motor portion. To effect the algebraic cancellation of the phase and frequency components associated with a varying shaft rate the windings of one of the rotors must be electrically reversed from the other. The reversal is preferably a full 180 degree reversal in electrical polarity, best achieved by a reversal of the winding polarity in the rotor stage. The resulting algebraic cancellation is discussed at length in the U.S. Patents to Nickoladze.

Those skilled in the art will know that by common practice the conductors in a rotor are paired to form series connected coils that often have a span close to one pole pitch, or 180 degrees electrical. When rotated within a revolving stator magnetic field an induced voltage appears on the rotor winding: which includes some rate difference in a singly excited induction device. Thus a slip rate is inherent in a singly fed device.

The voltage appearing at the rotor, therefore, lags by the slip rate determined by the torque balanced and the propagation of the rotating stator field vector. Full and unambiguous algebraic cancellation can therefore be achieved if the electrical polarity of one of the rotors on the shaft is exactly opposite to the electrical polarity of the other.

Such complete polarity reversal can be achieved in a conventionally wound rotor by reversing the polarity of all of its windings. This can be simply effected by bringing out both side ends of the rotor windings for connection. In this manner a full electrical polarity reversal can be effected without any necessity of phase alignment or correction.

Accordingly, by effectively reversing the electrical polarity of the rotors the algebraic cancellation previously described in U.S. Patents to Nickoladze and is exactly effected.

More specifically, by connecting both stators to a three-phase 60-cycle conventional supply and by interconnecting the rotor windings for a reversed electric polarity between each other one of the rotors will then algebraically cancel the out of phase components of the other. For this reason both the winding ends of each rotor winding are brought out to a connection array which then is connected in accordance with a testing procedure disclosed herein which resolves the polarity ambiguity inherent in wound rotors. Thus rotors wound by conventional techniques are rendered useful by way of the method set out.

Furthermore, once the proper terminals are determined by the test technique disclosed their bridging connections may then include the R-L-C compensation for expanding operating range and linearity.

In the past such compensation was typically applied to the primary side of the induction device (see, e.g., U.S. Pat. No. 2,648,808 to Tiede and U.S. Pat. No. 9,055,795 to Methien). The closed rotor windings of a singly fed device have characteristically not been connected for compensation. A singly fed induction device exhibits a linear increase in rotor current with slip rate. This linear increase continues until the out-of-phase component of the rotor impedance becomes dominant. At this point the torque relationship with slip rate begins to fall off significantly, thus defining the operating peak of the device. Accordingly, as the out-of-phase components increase, the field pattern by which torque is produced becomes less favorable.

By inserting resistance into the foregoing circuit, i.e., into the rotor loop, a decrease in the in-phase current results with a consequent reduction in torque slope. Thus, a single fed device in which resistance is increased will exhibit a wider operating range, but at a lower power. This effect of rotor resistance is well known and is typically avoided in prior art.

In accordance with the present invention the insertion of capacitors and chokes into the resistance path of the rotor loop will oppose the inductive, out-of-phase component, thus effectively expanding the operating range.

One should further note an induction device is fully reversible in operation. Simply, the current field and armature in a singly fed device are terms defining the structural components to which electrical connection is made. Accordingly, an armature may be a stationary component while the field may be rotated, with the electrical connections thereto effected by slip range. In this form the stationary loops of the armature may be measured for current phase angle and servo mechanism may then be used to adjust the R-L-C elements inserted into the loop.

In a second alternative a compound winding arrangement of a singly-fed device is compensated by insertion of the R-L-C network between the windings. This insertion then effects a phase change between the windings, thereby improving the dynamic range of the compound device. More importantly, the selection of the R-L-C values allows for shaping of the rotary performance of the device which then permits its matching to the power source.

These, as well as other objects, features and benefits will now become clear from a review of the following detailed description of illustrative embodiments and the accompanying drawings.

### BRIEF DESCRIPTION OF DRAWINGS

FIG. 1 is an electrical schematic representation of a motor multi-stage inductive assembly;

FIG. 1A is a perspective view of a motor multi-stage inductive assembly;

FIG. 1B is an electrical schematic representation of motor multi-stage induction assembly;

FIG. 2 is an electrical schematic representation of a motor multi-stage inductive assembly with the windings of the rotors opened;

FIG. 2A is a diagram illustrating induction motor parameters as a function of relative rotation of the rotors or stators;

FIG. 2B is a diagram showing the torque as a function of resistive compensation;

FIG. 2C is a schematic representation of a motor inductive assembly with resistive and inductive compensation;

FIG. 3A is a vector diagram showing the relative phases and amplitudes of the voltages in the rotor windings in one embodiment of the present invention;

FIG. 3B is a vector diagram illustrating the amplitudes and phases of the voltages in the windings of the rotor in accordance with another embodiment of the present invention;

FIG. 3C is a vector diagram showing the amplitudes and phases of the voltages in the rotor windings in accordance with another of the present invention;

FIG. 3D is a perspective view of a rotor;

FIG. 4 is an electrical schematic representation of a motor multi-stage inductive device having resistive and capacitive compensation;

FIG. 4A is a perspective view of the windings of a rotor;

FIG. 5 is an electrical schematic representation of a motor inductive assembly with resistive capacitive and inductive compensation and a redundant rotor and stator;

FIG. 5B is an electrical schematic representation of a motor inductive assembly having resistive and capacitive compensation with a servo;

FIG. 6 is an electrical schematic representation of a motor inductive assembly having resistive and capacitive compensation with a servo; and

FIG. 7 is an electrical schematic representation of a motor 10 inductive assembly having resistive, capacitive and inductive compensation.

### DETAILED DESCRIPTION OF ILLUSTRATIVE EMBODIMENTS

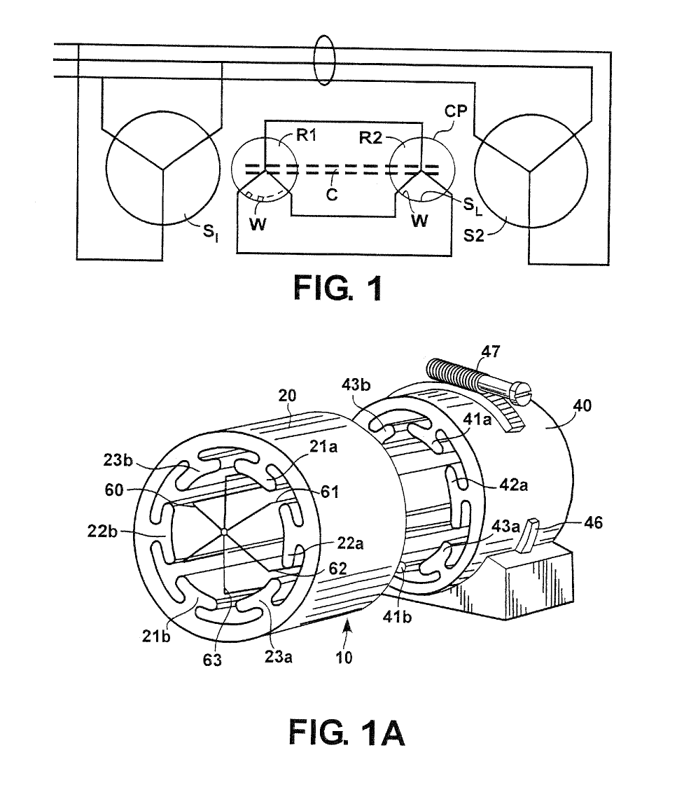

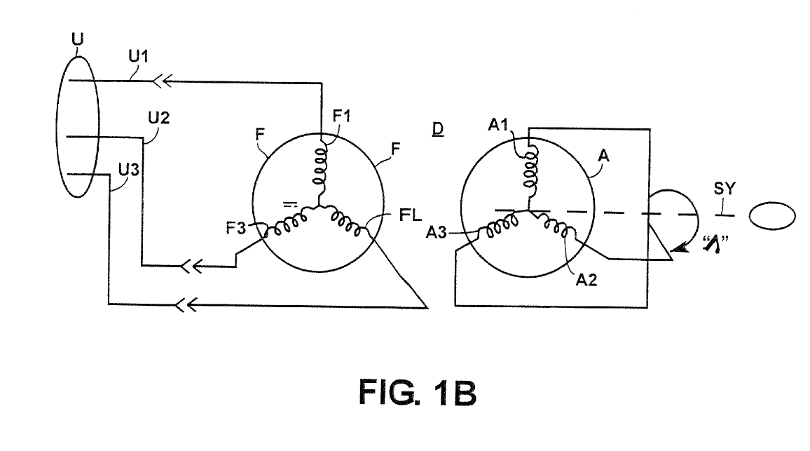

As shown in FIG. 1 the inventive motor multistage inductive assembly, A of the type described in prior U.S. Pat. Nos. 4,701,691 and 4,229,689 is characterized by a first and second stator S1 and S2 and a first and second wound rotor R1 and R2. Each wound rotor assembly R1 and R2 is fixed on a common shaft C disposed for rotary advancement by a local power source P.

In this arrangement the rotors R1 and R2 may be implemented in accordance with conventional practice as a wound assembly in which a series of windings W are laid into slots SL formed in a core piece CP. Once thus installed the core piece with the windings thereon is typically varnish impregnated for structural retention against centrifugal forces and environmental protection.

In this form, each winding when closed upon itself in squirrel cage fashion will have a particular phasing an, polarity. In order to interconnect as shown in FIG. 1, the polarity must be determined.

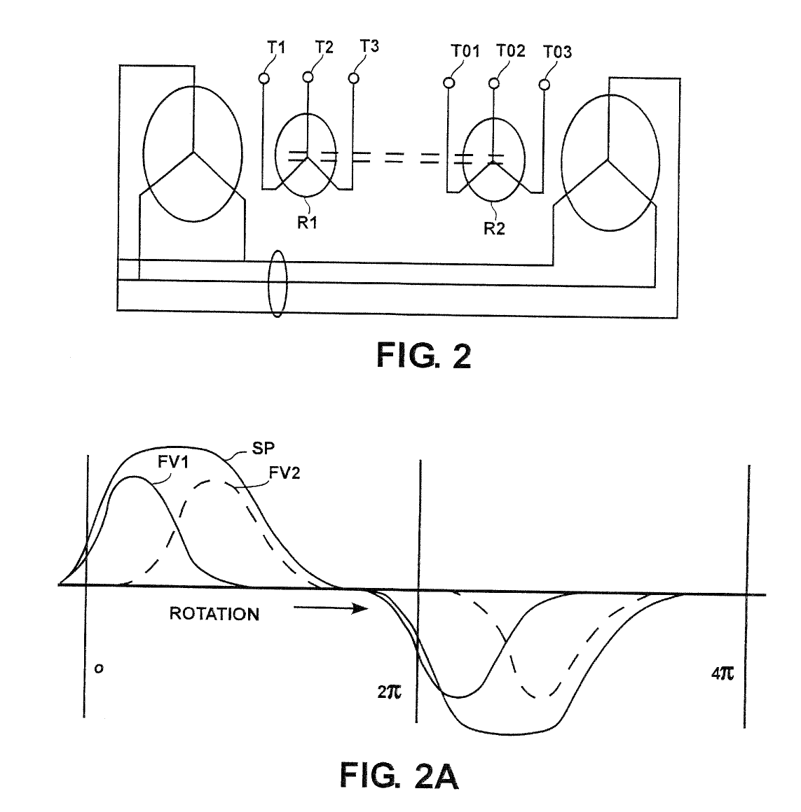

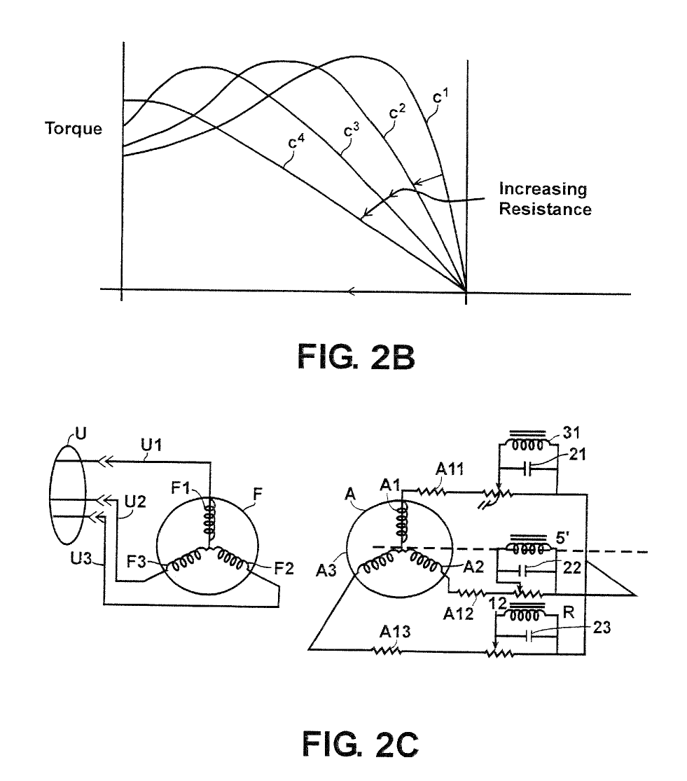

As shown in FIG. 2, the windings of rotors R1 and R2 are opened with individual leads made available for connection terminals T1, T2, and T3 for rotor R1 and terminals T01, T02 an T03 for rotor R2. Concurrently, the stators S1 and S2 are connected in parallel to the utility grid U with the shaft C locked so no rotation will occur. The effective electrical result is two three phase transformers in parallel. The stators S1 and S2 comprise the primary with the rotors R1 and R2 being the secondary.

As the mechanism of construction is that of a wound rotor motor, the means of excitation may be inverted. That is the rotor terminals may be substituted for the transformer primary with the stator terminals becoming the transformer secondary. The ability of the machine to allow this dual format of connection to the utility enhances its versatility.

The proper alignment of the winding elements of stator S1 and stator S2 relative to rotors R1 and R2 requires a probable physical movement of one element within the machine structure. The windings are connected and energized as a parallel transformer as previously mentioned. A voltmeter is connected to terminals T1 and T01. An individual rotor or stator is rotated upon its own axis within the machine structure until the maximum voltage is observed. The rotor or stator is now secured within the structure in this new position.

Having found the proper alignment of each rotor or stator, the interconnection process may be undertaken.

Apply rated voltage and frequency to rotors R1 and R2 25 through the ring and brush assembly with all stator leads left open. Measure the induced voltage at the leads T1-T2, T1-T3, and T2-T3 Also measure the induced voltage at leads T01-T02, T01-T03, and T02-T03. This voltage called Vm should be consistent between all terminals.

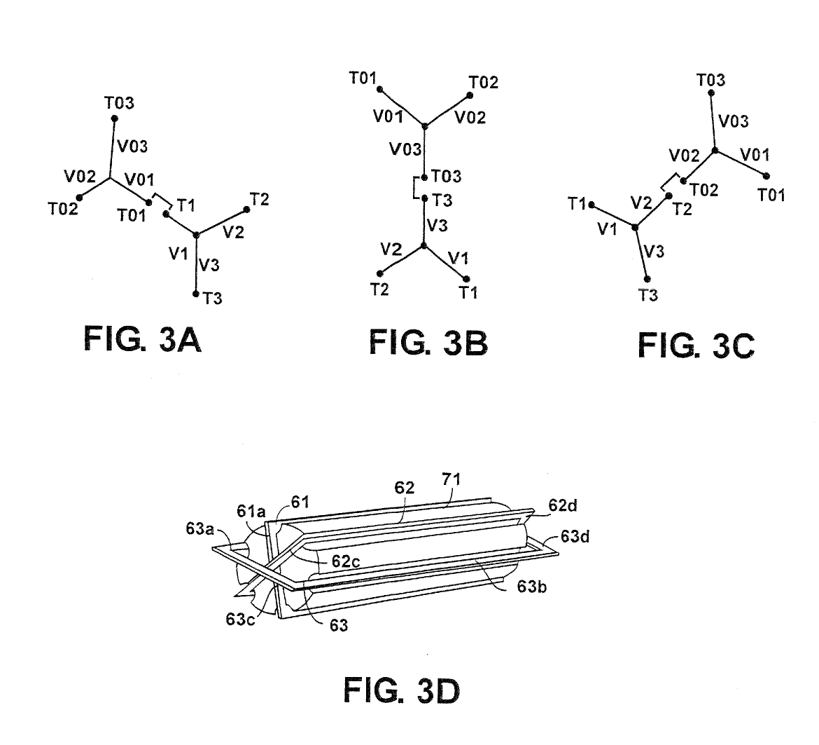

The interconnection is shown in FIG. 3A. Phase A of both windings are interconnected when terminals T1 and T01 are use for alignment. This solution is not unique. If terminals T3 and T03 are use the interconnection is shown in FIG. 3B, and the terminals T2 and T02 follow in FIG. 3C.

The connection of terminal T1 and T01 force this segment of each winding to be an equal but opposite polarity voltage effecting the electrical cancellation. For a 3 phase set of windings the voltage induced into the remaining open leads will have the following values which may be proven via geometry.

| | |
|---|---|
| T2 to T02 = | 2 Vm |
| T3 to T03 = | 2 Vm |
| T2 to T03 = | 3 |
| T3 to T02 = | 3 Vm |

The possibility of two other solutions as previously described will result in the same relationships with their respective lead combinations.

Any other combination of connections will include out of phase components and will not include the proper vector cancellation.

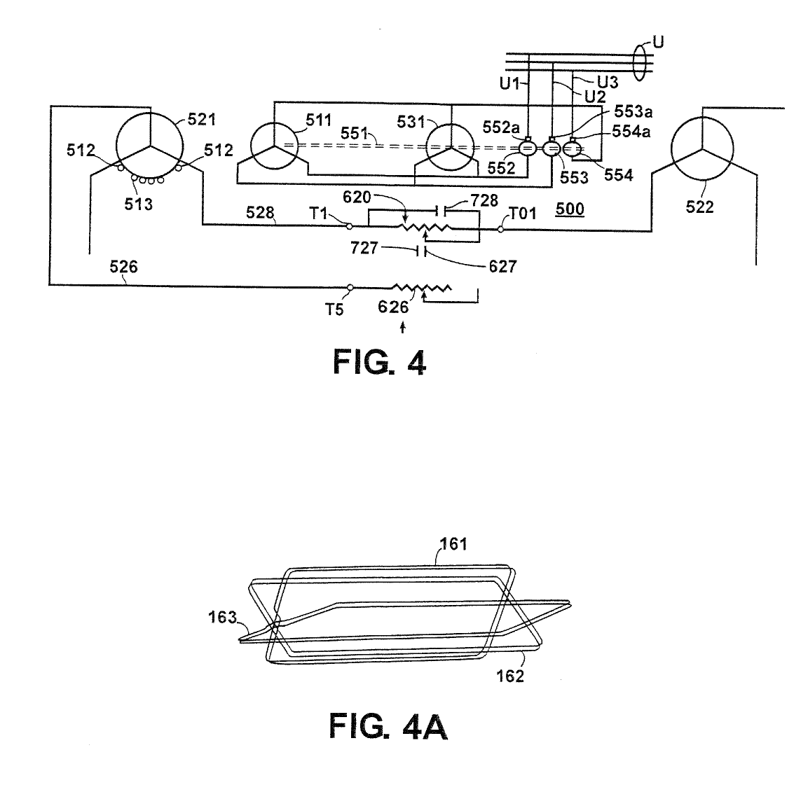

Construction enhancements may be considered for convenience of alignment as shown in FIG. 4. Stator 521 may include a roller assembly 512 and a worm screw 513 (or similar) for manual adjustment of the stator position. Also, small phase deviations may be trimmed.

Of course, the winding polarity in a wound assembly is initially ambiguous. Simply, in a singly fed device each winding T1, T2, T3 and TO1, T02 and T03 closes on itself. Thus, when conventional wound rotors are to be used it is necessary to determine the polarity of each opened winding. This is necessary for correct vector addition as shown in FIGS. 3A, 3B and 3C. In this figure the electrical vectors T1, T2, T3 and TO1, T02, and T03 correspond to the windings and are shown in a vector coordinate system in which the vector space of setup S1 and S2 is identical. Thus, a full 180 degree electrical phase reversal requires the following considerations:

(i) The vector alignment of the stator windings;

(ii) The relative orientation of the rotors on the common shaft; and

(iii) The resolution of each rotor winding polarity.

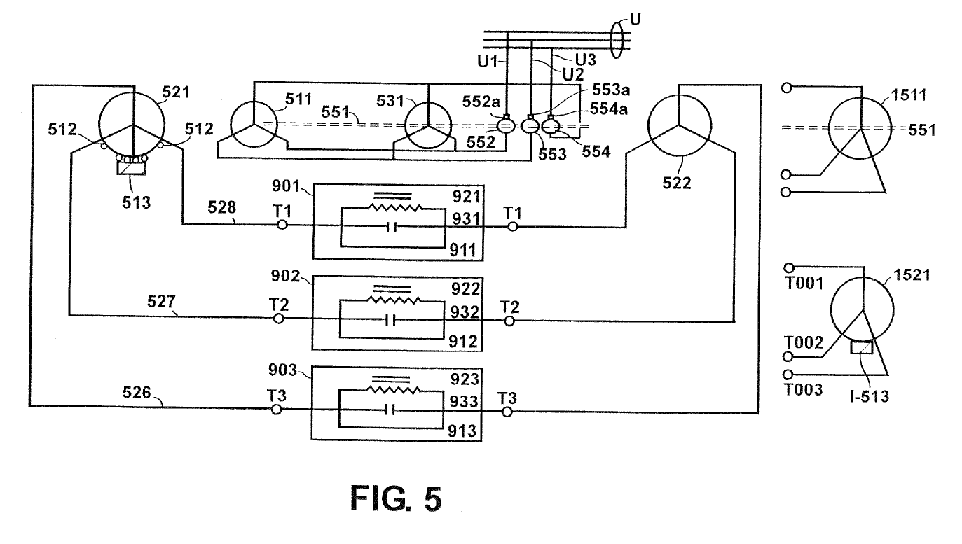

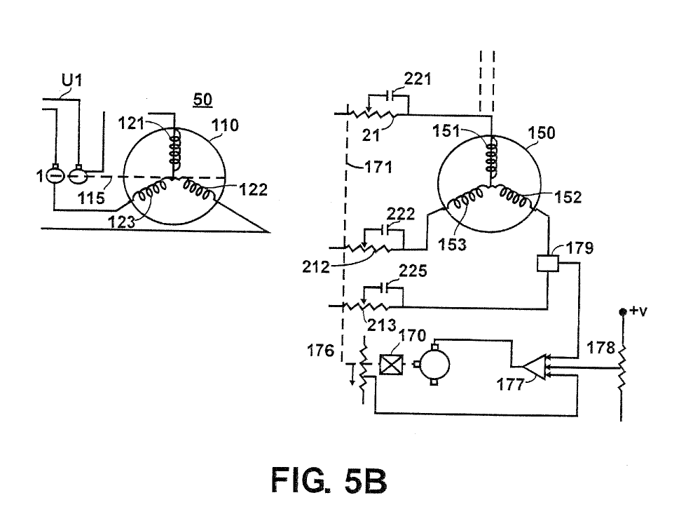

Of these items, (i) and (ii) are resolved concurrently by locked rotor testing in which the combination is tested, at a reduced excitation level, in the manner of a transformer equivalent. This equivalent circuit is shown in FIG. 5. In this equivalent circuit RE is the equivalent total resistance, the term XE is the equivalent electrical component in quadrature, IB is the line current to the stators and VB is the line voltage (3 phase stator).

The equivalent phase impedance JZ E equates:

$$ZE = \frac{VB}{V 3 {I}_{B}}$$

$$and the equivalent leakage reactance XE equates \text{:}$$

$$XE = {ZE}^{2} - {RE}^{2}$$

Thus, by inserting compensation into the rotor interconnections and, concurrently, by adjusting for 180 degree phase polarity of the rotor windings a condition may be achieved which fully compensates all of the quadrature terms, including the leakage reactance.

Once proper alignment and connection is established, shown in FIG. 4, electrical compensation may then be inserted between each terminal pair. Thus potentiometers 626, 627 and 628 in parallel with capacitors 726, 727 and 728 may be inserted between the respective terminals to expand the operating range of the device. Yet another rotary advancement mechanism shown by worn screw 1513 may then be utilized when substituting for the terminals T1, T2 and T3 or T01, T02 and T03.

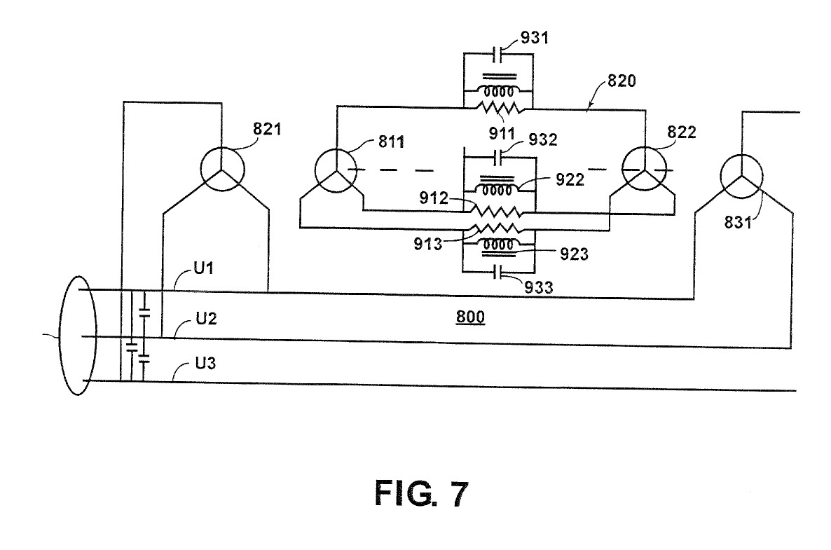

By further reference to FIGS. 4 and 7, the effect of compensation resistance inserted between the cross-connecting terminals results in an expanded operating range allowing higher operating speed. In this instance, compensation networks 901, 902 and 903 effect the terminal interconnection described above, 10 network 901 including a resistor 911, in parallel with a choke 921 and a capacitor 931; network 902 comprising resistor 912 in parallel connection with choke 922 and capacitor 932; and network 903 comprising resistor 913, choke 923 and capacitor 933. It has been found that by increasing the resistance of resistors 911, 15 912 and 913 from approximately 0 ohms to about 5.8 ohms the dynamic range expressed in ratio of both the power factor PF and efficiency EFF are substantially increased.

Of course, other values of compensation resistance will produce other expansions of operating range, generally also affected by the winding resistance of the stator and rotor windings in each instance, and the particular gap reactance of the mechanical structure.

As shown in FIG. 1B, a prior art induction device, generally shown at D, typically includes a field F magnetically coupled to an armature or rotor A on a rotary shaft S1 tied to receive ox transmit mechanical power P. In this configuration the field F is electrically connected to a utility grid which by common practice is in three phases. Thus, field F is conformed as three-phase device, including three field windings F1, F2 and F3 which, in conventional manner, induce electrical signals into the winding of armature A.

In this form the induction device is of the singly fed configuration, there being no secondary feed to the armature A. As stated above, this configuration is well known in the art, many examples thereof being found in induction motors or generators. In typical practice the motor A may include its own windings A1, A2 and A3 of either Y or delta connection. These windings A1-A3, in response to the magnetic vector in the field F, then carry an induced voltage and thus exchange electrical power with mechanical power.

Mechanical power, or torque, occurs only in the presence of a phase offset between the field vector and the armature vector and devices of this kind develop power by developing slip rate. The induced current in the rotor loops A1-A2 is then at the frequency of such slip rates. Thus, as the mechanical shaft rate N departs from the field magnetic vector the frequency content in the armature winding increases.

Moreover, such variations in frequency include phase angle A following the relationship:

$$0 = tan \frac{sx}{r} \qquad ( 1 )$$

where S is the slip rate, r is the loop resistance, and x is the magnetic reactance across the air gap. At the same time the produced shaft power is expressible as a virtual winding resistance, or:

$$Rm = \frac{r}{s} ( 1 - S ) \qquad ( 2 )$$

where Rm is the virtual resistance. Thus, as the slip rate S increases in both the motor and generator directions the virtual resistance drops, increasing armature current. This effect dominates for small power factor angles phase. When, however, the power factor angle becomes large, the out-of-phase components predominate and the power curve drops off in consequence. Thus, the typical prior art device will exhibit “peaky” power characteristics shown in FIG. 2B as a family of curves C1-C4 for various armature winding resistances. This peaky powerform defines the limited operating range of most prior art devices.

By reference to FIG. 2C, the forgoing prior art performance characteristics may be substantially improved by the inventive insertion of compensative elements in each winding A1-A2 of the inductive device. More specifically, potentiometers 11, 12 and 13 are connected in series in each winding, each potentiometer having the wiper connected across a bridging capacitor 21, 22 and 23 to one end thereof. Thus, manual adjustment of potentiometers 11, 12 and 13 adjusts the bridged resistive series segment. As a result the increasing slip rate S will pass, to a large extent, across the bridging capacitors 21, 22 and 23. Consequently, a 15 current lead factor is inserted into the armature loop which increases with slip rate.

To further shape the frequency response chokes 31, 32 and 33 may be connected across the corresponding capacitors 21, 22 and 23 thus allowing for full compensation of the phase effects previously designated. The resulting performance, shown in FIG. 48, expands the dynamic range of the inductive device thus modified in accordance with the family of curves P1-P9 for varying wiper positions.

Of course, the forgoing curves only generally illustrate the 25 result obtained. It is to, be noted that the resistance of potentiometers 11, 12 and 13 is in series with the winding resistance A11, A12 and A13 of the armature windings A1, A2 and A3. The selection of these impedances will therefore depend largely on the design characteristics of the motor and is best accomplished by those skilled in the art.

Alternatively, as shown in FIG. 5B, the operative aspects of the armature and field may be reversed. In this configuration generally designated by the numeral 50, a rotary field 110 is fixed to a shaft 115 which also supports, in rotation; three slip rings 110, 117 and 118 in wiping contact with the leads U1, U2 and U3 of a three-phase utility grid U. The slip rings, in turn, are connected to field windings 121, 122 and 123 aligned for magnetic coupling with windings 151, 152 and 153 of a stationary armature 150. Each of the windings 151, 152 and 153 includes, in circuit therewith, a corresponding potentiometer 221, 212 and 213 with a bridging capacitor 221, 222 and 223 connected to each wiper thereof.

The potentiometer (i.e., their wipers) are then fixed for common adjustment by the shaft 171 a servo motor gearhead 170 which also drives a centertapped feedback potentiometer 176. The wiper of potentiometer 176 is then summed at summing amplifier 177 with the output of a phase detector 178 tied to sense the power factor angle (phase angle) in one of the windings 151, 152 or 153. Summing amplifier 177, moreover, may receive yet another bias input from an adjustable resistor 179 tied to a reference signal produced in a conventional manner.

Of course other elements, like chokes, may be further inserted into the circuit to fully shape the dynamic response of the assembly, the selection thereof, being determined by the design considerations of the inductive device.

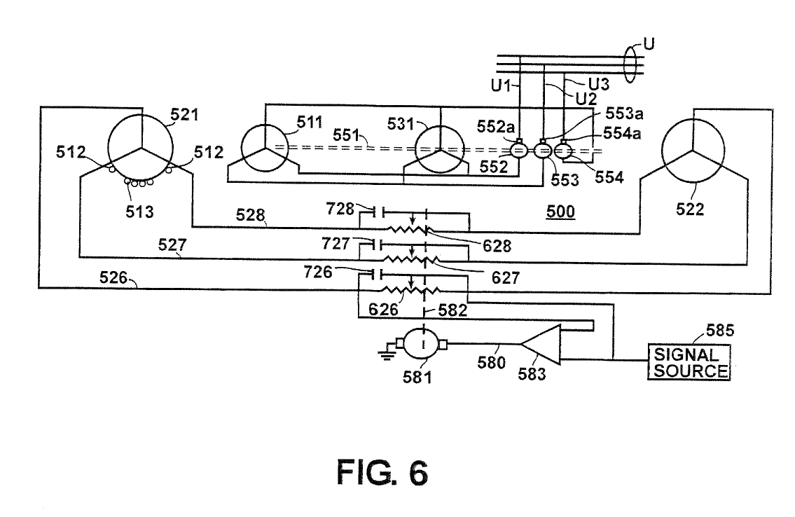

These same compensation effects may be applied to a compound device illustrated in detail in FIG. 6 and generally designated 25 by the numeral 500, conformed to operate as a synchronous generator with a rotary shaft 551 provided with slip rings 552 553 and 554 at one end. Each such slip ring then provide contact with a three-phase utility grid U and also connects i parallel with the windings of a first three-phase stator assembly 511 and a second three-phase stator assembly 531 fixed to the same shaft. Stators 511 and 531 then rotate 521 and 522 interconnected to each other by inverted interconnection leads 526, 527 and 528. It is these leads that, are provided with potentiometers 626, 627 and 628 in brush connection wil35capacitors 726, 727 and 728, A servo loop 580 is then useful rotate the wiper contact of the potentiometers to obtain a desired voltage drop there across.

A common rotor 60 extends through the annular interiors of stators 20 and 40 and thus cuts the respective magnetic fields in the course of rotation. As a consequence opposedly induced currents are developed in the opposite sides of the rotor, conformed as an inductor by way of a plurality of isolated loops 61, 62, 63, 64, 65 and 66.

In the foregoing arrangement each of the loops 61-63 may be implemented by way of isolated windings or by isolated bars of a squirrel cage rotor design. Thus, as shown in FIG. 2A, two opposed induced current wave forms are generated in each loop 15 passing through each stator field. Since each loop is isolated from the others no cross over current flow occurs.

With these current flows a rotor having a number of loops (poles) equal to the stators will exhibit a magnetomotive force as follows:

M=0.4(2)KNMIej^{swt}

Where the term K is the induction factor, I is the induced current, N is the turns per phase, M is the number of phases and S is the slip angle. This magnetomotive force then reacts with the magnetic field of the stator to produce the torque.

In the foregoing relationship only a single induced current is treated. A two-stator configuration will superpose two induced currents phased apart by the angular displacement of the stators 20 and 40, a phase angle p. Accordingly, the induced total magnetomotive field Mtot is now expressed as:

M_{Trr}=0.4(/s)KNMI(e^{jswt}+e^{(j(sp)wt})

Thus, a superposition SP of two field vectors FV1 and FV2 is created in each loop 61-63 as these loops pass through the stator fields, the peak of the superposed vector SP then adjusting to a new slip angle corresponding to the net rotational rate.

As a consequence, the angular rate of the rotor 60 falls off with the angular displacement p of stator 40 relative stator 20 and at a 180 degree stator alignment a zero angular rate results. One should note that the foregoing superposition of induced magnetomotive field vectors is best achieved with isolated rotor loops. Simply, an isolated loop maintains the induced currents in a superposed relationship. As result the induced magnetic vector expressed as the wave form SP will align at an equilibrium slip angle which is one stator will act as a generator to return a portion of the loss.

In contradistinction, electrically connected loops in the rotor, as conventionally practiced will generate current flows across the loops with a net field vector alignment which forms a helical pattern around the rotor. The rotor thus contains little, if any generating components, and therefore, the rotor speed is simply a compromise of the various slip angles.

As shown in FIG. 3D, a squirrel cage rotor 60 is illustrated including the above mentioned loops 61, 62 and 63 each conformed as conductor sections 61a and b, 62a and h, and 63a and b embedded in an iron core 71. The ends of conductors 61a and b connected to each other by cross rotor shorting bars 62c and d which are isolated from shorting bars 62c and d and 63c and d connecting across the ends of conductors 62a and b and 63a and b. Thus, three isolated current loops are shown which on crossing the magnetic fields of the stators 20 and 40 carry the superposed induced currents SP. The peak of this induced current, according to the illustration in FIG. 2A, will follow a substantially sinusoidal function with the adjustment angle p of stator. 40 between the maximum rate R and zero.

Accordingly, by isolating the conductor loops in the rotor an effect is obtained in which electrical generation results. Simply, at zero rotational rate the inventive motor acts like a transformer which because of the loop coupling transform at 360 degrees. Thus, in phase recovery is obtained through the 10 expedient of an isolated loop. This same effect can be realized by way of a wound rotor 160 as illustrated in FIG. 4A. Once again, each of the rotor windings 161, 162 and 163 is isolated from others to locate the induced current path. As a consequence, transformer action is achieved across the two stators, 20 and 40 to return a portion of the power into the line.

Obviously, many modifications and changes may be made to the foregoing without departing from the spirit of the invention. It is therefore intended that the scope of the invention be determined solely on the claims appended hereto.

While the specification describes particular embodiments of the present invention, those of ordinary skill can devise variations of the present invention without departing from the inventive concept.

We claim:

1. An induction motor, comprising: two rotors coaxially arranged on a shaft, a first one of the rotors having a first winding and a second one of the rotors having a second winding, said first winding being coupled to the second winding with reverse electrical polarity;
(a) two stators, each of the stators being coaxially arranged around a different one of the two rotors; and
(b) wherein one of the stators is mounted for rotation relative to the other stator.

2. The induction motor of claim 1 wherein each of the stators comprises a polyphase structure.

3. The induction motor of claim 1 further comprising capacitor coupled to the first winding.

4. An induction motor, comprising:
(a) first and second rotors coaxially arranged on a shaft, each of the rotors having a winding;
(b) a resistor coupled between the windings of the first and second rotors;
(c) a capacitor connected in parallel to the resistor; and
(d) first and second stators, the first stator being coaxially arranged around the first rotor and the second stator being coaxially arranged around the second rotor.

5. The induction motor of claim 4 wherein the resistor comprises a potentiometer.

6. The induction motor of claim 4 further comprising a choke connected in parallel with the capacitor.

7. The induction motor of claim 4 further comprising a worm screw coupled to the first stator to rotate the first stator with respect to the second stator.
